(19) United States
(12) Patent Application Publication
(10) Pub. No.: US 2004/0017189 A1
(43) Pub. Date: Jan. 29, 2004

(54) Method and apparatus for soft absolute position sensing of an electromechanical system output

(76) Inventors: Thomas E. Gyoergy, Clarkston, MI (US); Paschal J. Romano, Fenton, MI (US); Joyce D. Carsey, Swartz Creek, MI (US); Thomas W. Newman, Flint, MI (US); Melvin J. Thomas, Flushing, MI (US)

Correspondence Address: CANTOR COLBURN, LLP, 55 GRIFFIN ROAD SOUTH, BLOOMFIELD, CT, 06002

(21) Appl. No.: 10/207,313

(22) Filed: Jul. 29, 2002

(51) Int. Cl. G01B 7/30; G06F 15/00; G01B 7/14

(52) U.S. Cl. 324/207.22; 324/207.2; 324/207.21; 702/150

(57) ABSTRACT

A method for indirectly sensing absolute position of a mechanical output device of an electromechanical (EM) system is disclosed. In an exemplary embodiment, the method includes detecting the location of a reference point established within a defined range of travel of the mechanical output device, and tracking a relative position of the mechanical output device through the movement of an electromotive actuator within the EM system. The absolute position of the mechanical output device is determined by comparison of the tracked relative position of the mechanical output device to the established reference point.

### BACKGROUND

The present disclosure relates generally to sensing techniques in electromechanical systems and, more particularly, to a method and apparatus for soft absolute position sensing of an electromechanical system output.

A typical electromechanical control system includes an electromotive actuator (e.g., a brush or brushless motor), a mechanical transmission system (e.g., a geartrain), and a mechanical device output such as a rotating shaft or a linear stroking shaft. Generally, there is also some form of physical travel limit on the output, either inside of the mechanism or as part of the device being controlled. In most cases, a closed loop form of position control of the output is a desired system characteristic. With closed loop control, it is necessary to be able to detect the position of the device output.

In a conventional closed loop electromechanical system, the position information is obtained through a dedicated position sensor(s) coupled to the output mechanism. As depicted by the block diagram of the electromechanical system 10 in FIG. 1, the position sensor 12 provides a signal 14 to a control unit 16 that is mathematically related to the position of the mechanical output 18 of the system 10. The sensor 12 may implemented by any of a variety of known sensing devices including, but not limited to, potentiometric devices, variable differential transformers, magneto-resistive devices, Hall effect sensors, encoders, resolvers, synchros and the like, as well as combinations thereof.

However, one disadvantage of using a dedicated position sensor(s) results from the increased costs and space associated with the extra electronics needed to drive the sensor, as well as to receive and decode the output signal(s). In addition, there are extra electromechanical interfaces, extra sealing devices and extra space requirements outside and/or inside the output mechanism. Accordingly, it would be desirable to be able to implement a closed loop electromechanical system, including position sensing for closed loop control, but without the increased cost and space requirements associated with dedicated position sensing devices.

### SUMMARY

The above discussed and other drawbacks and deficiencies of the prior art are overcome or alleviated by a method for indirectly sensing absolute position of a mechanical output device of an electromechanical (EM) system. In an exemplary embodiment, the method includes detecting the location of a reference point established within a defined range of travel of the mechanical output device, and tracking a relative position of the mechanical output device through the movement of an electromotive actuator within the EM system. The absolute position of the mechanical device is determined by comparison of the tracked relative position of the mechanical output device to the established reference point.

In another aspect, a closed loop electromechanical (EM) system includes a control unit and an electromechanical actuator controlled by the control unit. The control unit is provided with rotational positional information of said electromechanical actuator. In addition, a mechanical output device having a defined range of travel is coupled to the electromechanical actuator. Reference point hardware is further used for detecting the location of an established reference point within the defined range of travel, wherein an absolute position of the mechanical output device may be indirectly determined by comparing the established reference point with the rotational positional information of the electromechanical actuator.

### BRIEF DESCRIPTION OF THE DRAWINGS

Referring to the exemplary drawings wherein like elements are numbered alike in the several Figures:

FIG. 1 is a schematic block diagram of an existing closed loop electromechanical (EM) system using a dedicated position sensor for a mechanical output thereof;

FIG. 2 is a schematic block diagram of a more specific implementation of the EM system of FIG. 1, in which the electric motor is a brushless electric motor having electronic commutation circuitry associated therewith;

FIG. 3 is a schematic block diagram of an alternative closed loop electromechanical (EM) system without the use of a dedicated position sensor and wherein the brushless electric motor is operated in a stepping fashion;

FIG. 4 is a schematic representation of a pair of obstructions affecting the range of travel of a mechanical output of the EM system in FIG. 3;

FIG. 5 is a schematic block diagram of a closed loop electromechanical (EM) system in accordance with an embodiment of the invention, wherein a reference point is used in conjunction with commutation sensing circuitry to provide for soft absolute position sensing for the EM system output; and

FIG. 6 a schematic representation of the pair of obstruction examples shown in FIG. 4, further illustrating the ability of the reference point to identify the location of the obstructions.

### DETAILED DESCRIPTION

Disclosed herein is a method of soft absolute position sensing for an electromechanical (EM) system output. Briefly stated, the method combines the relative position sensing of an EM actuator (i.e., a brushless motor) along with a fixed reference point within the range of travel of the mechanical output of the EM system. The reference point may be implemented through an inexpensive Hall effect switch or magneto-resistive switch, thereby saving space as compared with conventional position sensing circuitry. By combining the relative position information available from the commutation sensing devices associated with the brushless motor, along with the reference point information, the absolute position of the mechanical output may be determined indirectly.

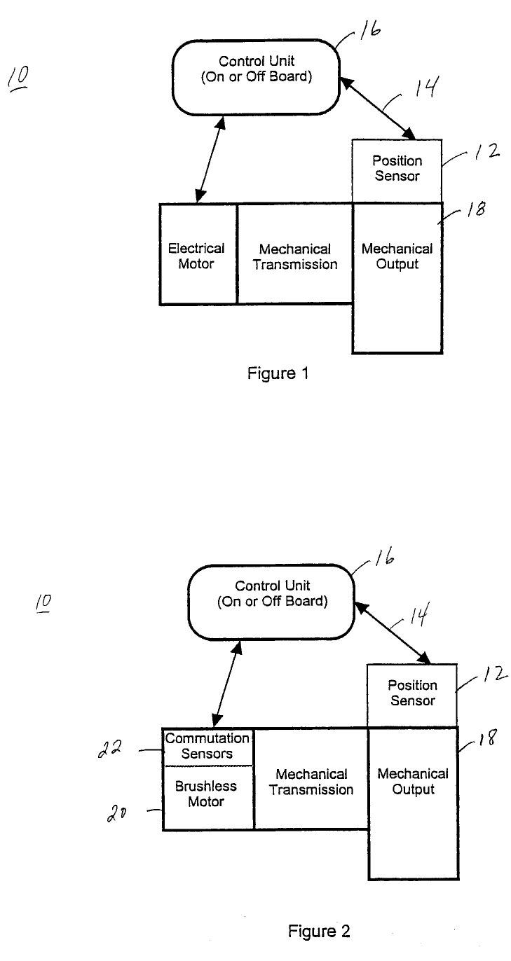

Referring initially to FIG. 2, there is shown a more specific embodiment of the existing closed loop EM system illustrated in FIG. 1. In this instance, the electromotive actuator is a brushless motor actuator (or EM actuator) 20 having commutation sensors 22 associated therewith. As stated previously, this convention EM system 10 includes separate position sensing components that also communicate directly with the control unit 16, providing direct position information regarding the mechanical output 18. In order to reduce the cost of the system as well as to eliminate extra component space claim and sealing requirements, then, the position information derived from position sensor 12 may instead be derived from the commutation sensors 22 themselves.

FIG. 3 illustrates an alternative EM system 30 in which the brushless DC motor actuator 20 is operating in a stepping fashion. To properly drive the actuator 20, an appropriate commutation sensing scheme, such as Hall effect switches, may be used as the commutation sensors 22. Through the commutation sensors 22, the relative position of the motor output shaft is known. Then, through the mechanical transmission system 24, the relative position of the mechanical output 18 may be inferred based upon the mathematical translation of the mechanical transmission system 24. In other words, the position of the output 18 is proportional to the number of steps the motor actuator 20 has taken. However, this is only a relative position. If the control unit 16 is able to sweep the motor (and thus the output 18) to determine the location of the travel limits (illustrated in the legend in FIG. 3), then the position of the output 18 can be determined in a less relative manner. The travel limits (denoted by 0% travel and 100% travel) could be detected when the motor actuator 20 stalls in each direction of travel. Such a method may be referred to as a “step counting” method of position sensing.

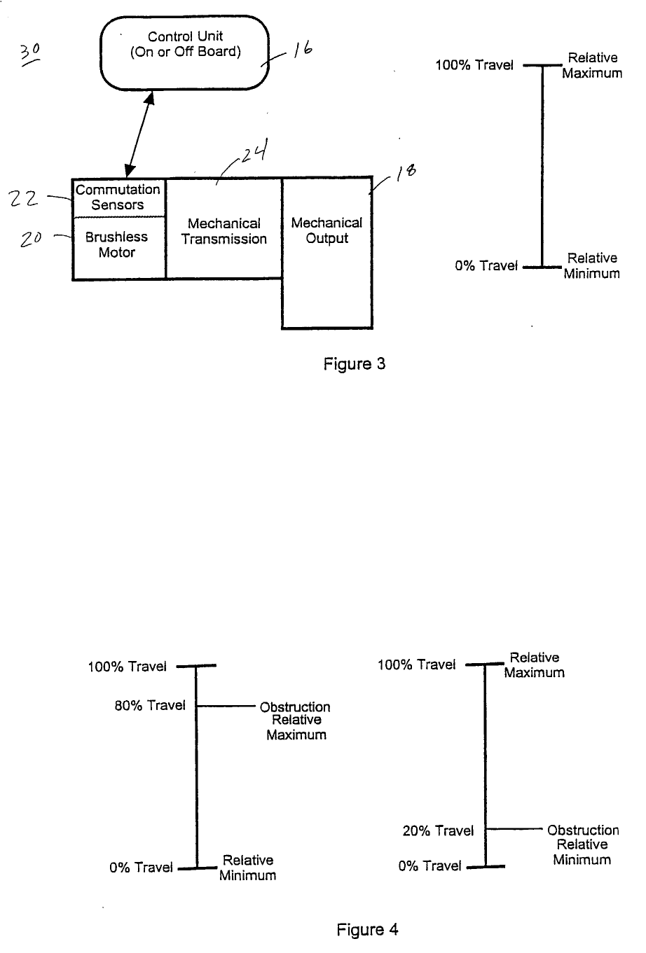

In the real world application of a high precision system, the actual physical location of the mechanical travel limits are often subject to change due to wear, creep, yield, breakage, obstruction, etc. As a result, it would be advantageous for the control unit 16 to be able to recognize such a condition so that it could be identified for on-board diagnostic requirements and for subsequent corrective measures. For example, the legends shown in FIG. 4 illustrate a pair of examples wherein obstructions are present in the EM system. In the first example, an obstruction is located at a point representing 80% of the maximum range of travel from the relative minimum point. In the second example, the obstruction is located at 20% of the maximum range of travel from the relative minimum point. In either case, the total range of travel of the mechanical output is now only 80% of the previous maximum.

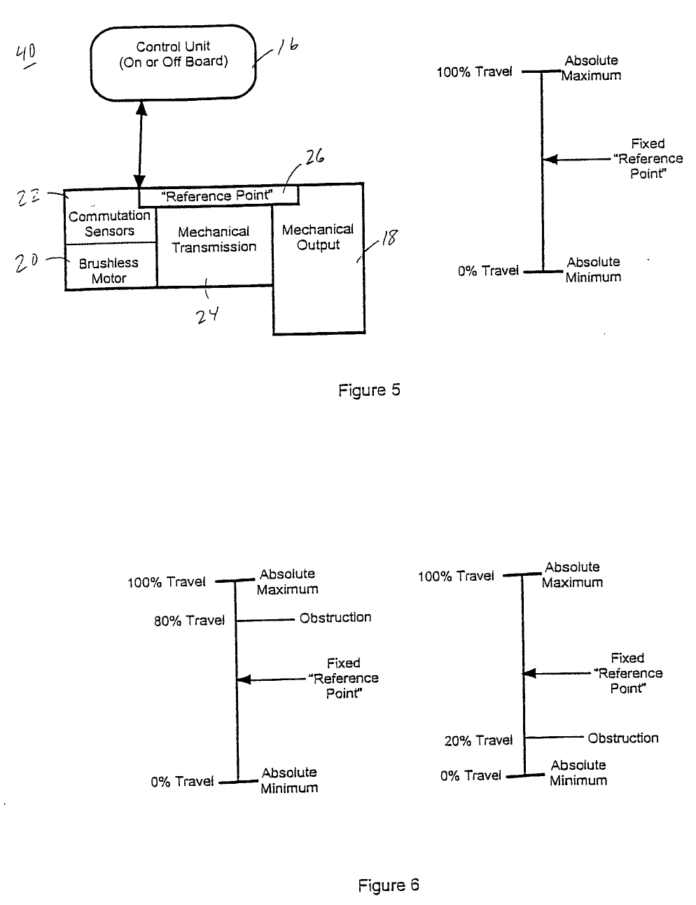

It will be noted that the step counting method, when used by itself, is not able to distinguish the two obstruction cases from one another. In other words, the system does not know whether a stoppage in the movement of the mechanical output is the result of an obstruction or whether it is a true end of travel limit. However, the ability of the control system to take the appropriate remedial action is dependent upon identifying the difference between these two situations. Therefore, in accordance with a further aspect of the present disclosure, a fixed reference point is defined within the range of travel of the actuator, as is illustrated in FIG. 5.

As can be seen from the revised closed loop EM system 40 diagram of FIG. 5, the sensing hardware for the added reference point 26 is schematically shown as being flexibly locatable within the system 10. For example, the reference point 26 may be located along with the commutation sensors 22, the mechanical transmission 24, or on the mechanical output 18 itself. In addition, the reference point 26 may be implemented with a relatively simple and inexpensive device such as a Hall effect switch or a magneto-resistive switch. Upon power-up of the EM system, the mechanical output may be cycled through the range of travel until the fixed reference point is detected by an appropriate output signal or pulse from the reference point hardware.

Because drive electronics are already present for the commutation sensors 22 and/or other on-board electronics, there is not a need for separate electronics to process the signals generated by the reference point hardware. Preferably, the reference point output signals are preferably sensed through a simple, discrete logic level means. As such, the space claim associated with the reference point 26 is relatively small, thereby eliminating any extra component-sealing arrangements. Compared with a dedicated position sensor, the overall sensing scheme of the present disclosure is less expensive, since the commutation sensors 22 are absorbed as part of the brushless motor cost.

It will thus be appreciated that the use of fixed reference point provides a true measure of absolute position sensing. Since each step count measurement is done with respect to the reference point, any deviation from the nominal output travel conditions may be determined. For example, the obstruction examples previously presented in FIG. 4 are now distinguishable from one another because the relative position measurements are also taken with respect to the reference point, as illustrated in FIG. 6. Finally, in addition to the features described above, the reference point may also be utilized to determine whether a miscount occurred in the step-counting process of the brushless motor actuator 20. If so, the step count may be corrected as well. As stated previously, the location of the reference point is determined during the power-up process and is associated with the relative position of the EM actuator 20. During the course of normal operation, every time the system 40 sweeps the output 18 past the reference point 26, the relative position of EM actuator 20 (in “steps”) can be compared with this previously determined point. If there is a discontinuity between the current value and the previously determined value, then the control unit 16 can compensate and adjust the value of the relative position of the EM actuator 20, thereby correcting for the discontinuity.

As will also be appreciated, the present disclosure has wide applicability to various types of electromechanical systems. For example, in an engine throttle control system, the angular position of a throttle plate may be controlled by a motor actuator. If the throttle plate has a defined angular range of travel between 0 degrees (minimum air flow) and 90 degrees (maximum air flow), then the absolute position of the throttle plate may be indirectly determined by knowing the relative position of the stepper motor with respect to a reference point (e.g., 45 degrees) established between the travel limits. This, in turn, would eliminate the need for a separate sensor for the throttle plate.

The disclosed invention can be embodied in the form of computer or controller implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer or controller (e.g., the control unit 16), the computer becomes an apparatus for practicing the invention. The present invention may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for indirectly sensing absolute position of a mechanical output device of an electromechanical (EM) system, the method comprising:
detecting the location of a reference point established within a defined range of travel of the mechanical output device; and
tracking a relative position of the mechanical output device through the movement of an electromotive actuator within the EM system;
wherein the absolute position of the mechanical output device is determined by comparison of the tracked relative position of the mechanical output device to the established reference point.

2. The method of claim 1, wherein said electromotive actuator is a brushless DC motor.

3. The method of claim 2, wherein said brushless DC motor is operated in a stepping fashion.

4. The method of claim 1, wherein said detecting the location of a reference point further comprises detecting an output signal generated by reference point hardware included within the EM system.

5. The method of claim 4, wherein said reference point hardware comprises a Hall effect switch.

6. The method of claim 4, wherein said reference point hardware comprises a magneto-resistive switch.

7. A closed loop electromechanical (EM) system, comprising:
a control unit;
an electromechanical actuator controlled by said control unit, said control unit being provided with rotational positional information of said electromechanical actuator;
a mechanical output device coupled to said electromechanical actuator, said mechanical output device having a defined range of travel; and
reference point hardware for detecting the location of an established reference point within said defined range of travel;
wherein an absolute position of said mechanical output device may be indirectly determined by comparing said established reference point with said rotational positional information of said electromechanical actuator.

8. The EM system of claim 7, wherein said electromotive actuator is a brushless DC motor having commutation sensors associated therewith.

9. The EM system of claim 8, wherein said brushless DC motor is operated in a stepping fashion.

10. The EM system of claim 7, wherein said reference point hardware comprises a Hall effect switch.

11. The EM system of claim 7, wherein said reference point hardware comprises a magneto-resistive switch.

12. A storage medium, comprising:
a machine readable computer program code for indirectly sensing absolute position of a mechanical output device of an electromechanical (EM) system; and
instructions for causing a computer to implement a method, the method further comprising:
detecting the location of a reference point established within a defined range of travel of the mechanical output device; and
tracking a relative position of the mechanical output device through the movement of an electromotive actuator within the EM system;
wherein the absolute position of the mechanical device is determined by comparison of the tracked relative position of the mechanical output device to the established reference point.

13. A computer data signal, comprising:
code configured to cause a processor to implement a method for indirectly sensing absolute position of a mechanical output device of an electromechanical (EM) system, the method further comprising:
detecting the location of a reference point established within a defined range of travel of the mechanical output device; and
tracking a relative position of the mechanical output device through the movement of an electromotive actuator within the EM system;
wherein the absolute position of the mechanical output device is determined by comparison of the tracked relative position of the mechanical output device to the established reference point.
